(19) United States
(12) Patent Application Publication
(10) Pub. No.: US 2024/0051623 A1
(43) Pub. Date: Feb. 15, 2024

(54) VEHICLE SPAT DEVICE

(71) Applicant: AISIN CORPORATION, Kariya-shi, Aichi-ken (JP)

(72) Inventors: Ryota TACHI, Kariya-shi (JP); Shuhei UCHIDA, Kariya-shi (JP); Kazuya MATSUMOTO, Kariya-shi (JP)

(73) Assignee: AISIN CORPORATION, Kariya-shi, Aichi-ken (JP)

(21) Appl. No.: 18/366,443

(22) Filed: Aug. 7, 2023

(30) Foreign Application Priority Data
Aug. 9, 2022 (JP) 2022-127063

(51) Int. Cl. B62D 35/02

(52) U.S. Cl. CPC B62D 35/02

(57) ABSTRACT

A vehicle spat device includes: a housing; a spat that adjusts an airflow toward a wheel of a vehicle by being displaced between a storage position at which the spat is stored in the housing and a deployed position at which the spat is deployed from the housing; a drive link that rotates between a position at which the spat is disposed at the storage position and a position at which the spat is disposed at the deployed position; and a transmission link that is coupled to the drive link and the spat in a relatively rotatable manner and transmits power of the drive link to the spat. When an external force acts on the spat, the transmission link moves to change a relative position between the drive link and the spat by the external force, and retracts the spat in a direction toward the housing.

### CROSS REFERENCE TO RELATED APPLICATIONS

This application is based on and claims priority under 35 U.S.C. § 119 to Japanese Patent Application 2022-127063, filed on Aug. 9, 2022, the entire content of which is incorporated herein by reference.

### TECHNICAL FIELD

This disclosure relates to a vehicle spat device.

### BACKGROUND DISCUSSION

JP 2019-151303A (Reference 1) discloses a spat device as an aerodynamic reduction device that reduces air resistance of a front wheel when a vehicle is traveling. The spat device includes a spat that disperses air toward the front wheel to left and right in front of the front wheel, an elevating mechanism that elevates and lowers the spat, and a case that accommodates the spat. The spat is switched, by the elevating mechanism, between an operating state in which the spat is deployed in front of the front wheel and a stored state in which the spat is stored in the case.

When a vehicle including the spat device as described above is traveling, when an obstacle is present on a road surface on which the vehicle travels, the obstacle may come into contact with the spat in the operating state. In such a case, it is desirable to mitigate an impact acting on the spat device.

### SUMMARY

According to an aspect of this disclosure, a vehicle spat device includes: a housing; a spat that adjusts an airflow toward a wheel of a vehicle by being displaced between a storage position at which the spat is stored in the housing and a deployed position at which the spat is deployed from the housing; a drive link that rotates between a position at which the spat is disposed at the storage position and a position at which the spat is disposed at the deployed position; and a transmission link that is coupled to the drive link and the spat in a relatively rotatable manner and transmits power of the drive link to the spat. When an external force acts on the spat, the transmission link moves to change a relative position between the drive link and the spat by the external force, and retracts the spat in a direction toward the housing.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view of a vehicle including a spat device;

FIG. 2 is an exploded perspective view of the spat device;

FIG. 3 is an exploded perspective view of the spat device;

FIG. 4 is an exploded perspective view of a link unit of the spat device;

FIG. 5 is an exploded perspective view of a transmission link of the link unit;

FIG. 6 is a side view of the spat device when a spat is located at a storage position;

FIG. 7 is a side view of the spat device when the spat is located at a deployed position;

FIG. 8 is a side view of the spat device when the spat is retracted from the deployed position; and

FIG. 9 is a side view of the spat device when the spat is retracted from the storage position.

### DETAILED DESCRIPTION

Hereinafter, an embodiment of a vehicle including a vehicle spat device (hereinafter, referred to as a “spat device”) will be described.

### Configuration of Embodiment

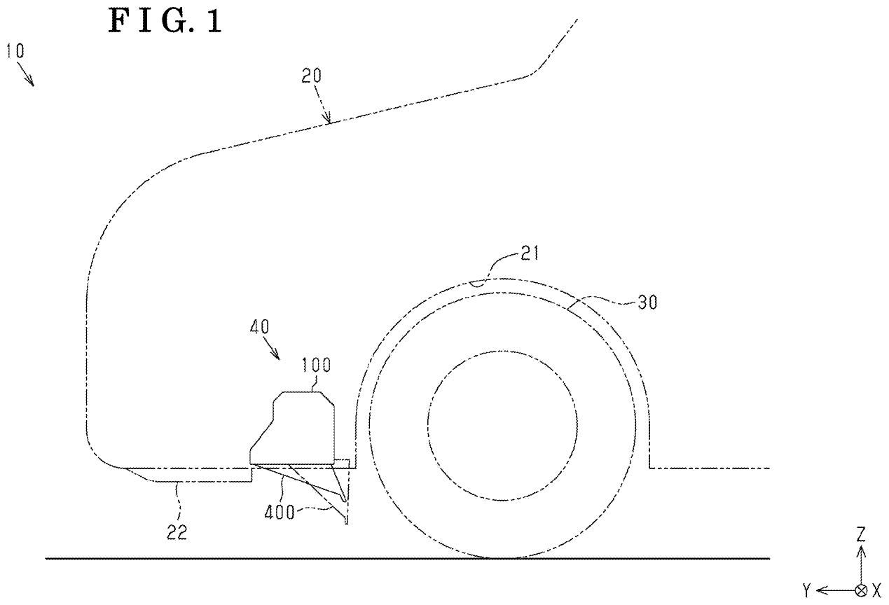

As shown in FIG. 1, a vehicle 10 includes a vehicle body 20, a front wheel 30, and a spat device 40. In the following description, a vehicle front-rear direction may be simply referred to as a front-rear direction, a vehicle width direction may be simply referred to as a width direction, and a vehicle up-down direction may be simply referred to as an up-down direction. In the drawings, an axis extending in the width direction is indicated by an X axis, an axis extending in the front-rear direction is indicated by a Y axis, and an axis extending in the up-down direction is indicated by a Z axis.

### <Vehicle Body 20>

The vehicle body 20 includes a tire house 21 that accommodates the front wheel 30 as an example of a “wheel”, and an undercover 22 that covers a bottom portion of the vehicle 10. The undercover 22 has a panel shape in which the width direction is a longitudinal direction and the front-rear direction is a lateral direction. The undercover 22 is provided in front of the tire house 21. The undercover 22 is made of, for example, an elastomer such as resin or rubber. The undercover 22 preferably has appropriate elasticity to be elastically deformable when an external force acts thereon.

### <Spat Device 40>

The spat device 40 is disposed between the undercover 22 and the front wheel 30 in the front-rear direction. The spat device 40 corresponding to the right front wheel 30 and the spat device 40 corresponding to the left front wheel 30 have substantially the same configuration except that the spat device 40 has a symmetrical shape in the width direction. Therefore, in the following description, the spat device 40 on the right side will be described.

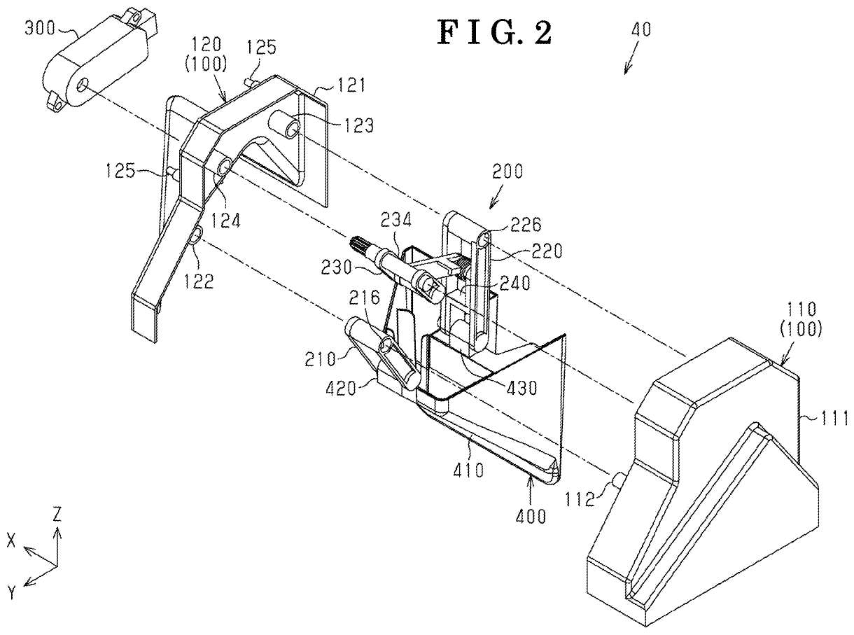

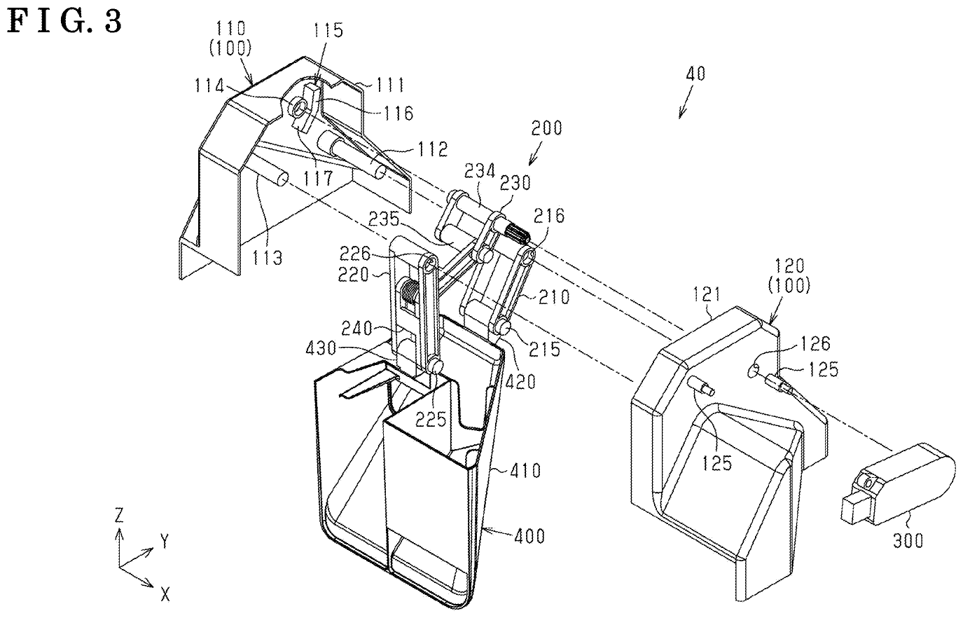

As shown in FIGS. 2 and 3, the spat device 40 includes a housing 100, a link unit 200, an actuator 300, and a spat 400.

### <Housing 100>

The housing 100 includes a first housing 110 and a second housing 120 which are separately configured. The housing 100 is implemented by integrating the first housing 110 and the second housing 120 in the width direction. The housing 100 accommodates and supports components of the spat device 40 excluding the housing 100.

The first housing 110 includes a first accommodating wall 111, a first support shaft 112, a second support shaft 113, a bearing portion 114, and a stopper 115.

The first accommodating wall 111 is a portion that covers the link unit 200 and the spat 400 from inside in the width direction. Therefore, the first accommodating wall 111 has a size capable of covering the link unit 200 and the spat 400. The first support shaft 112 and the second support shaft 113 have a columnar shape whose axial direction is the width direction, and the bearing portion 114 has a cylindrical shape. The first support shaft 112 is located forward of the bearing portion 114, and the second support shaft 113 is located rearward of the bearing portion 114. The stopper 115 is located adjacent to the bearing portion 114. The stopper 115 includes a first stopper 116 and a second stopper 117 having different inclinations in the up-down direction. The inclination of the first stopper 116 in the up-down direction is small, and the inclination of the second stopper 117 in the up-down direction is large. A lower end of the first stopper 116 is connected to an upper end of the second stopper 117.

The second housing 120 includes a second accommodating wall 121, a first bearing portion 122, a second bearing portion 123, a third bearing portion 124, and two fixed shafts 125.

The second accommodating wall 121 is a portion that covers the link unit 200 and the spat 400 from outside in the width direction. Therefore, similarly to the first accommodating wall 111, the second accommodating wall 121 has a size capable of covering the link unit 200 and the spat 400. As shown in FIG. 2, the first bearing portion 122, the second bearing portion 123, and the third bearing portion 124 are provided on the second accommodating wall 121. The first bearing portion 122, the second bearing portion 123, and the third bearing portion 124 have a cylindrical shape whose axial direction is the width direction. Inner diameters of the first bearing portion 122 and the second bearing portion 123 are equal to outer diameters of the first support shaft 112 and the second support shaft 113 of the first housing 110. The first bearing portion 122 is located forward of the third bearing portion 124, and the second bearing portion 123 is located rearward of the third bearing portion 124. As shown in FIG. 3, an insertion hole 126 penetrates the third bearing portion 124 in the width direction. The two fixed shafts 125 extend outward in the width direction from the second accommodating wall 121. The two fixed shafts 125 are located with an interval in the front-rear direction.

### <Link Unit 200>

As shown in FIGS. 2 to 4, the link unit 200 includes a front link 210, a rear link 220, a drive link 230, and a transmission link 240. In the embodiment, rotation axes of the various links constituting the link unit 200 extend in the width direction. The link unit 200 is configured to transmit power of the actuator 300 to the spat 400. In the following description, a first end and a second end in the longitudinal direction of a rod-shaped member such as the link are simply referred to as a first end and a second end.

### <Front Link 210>

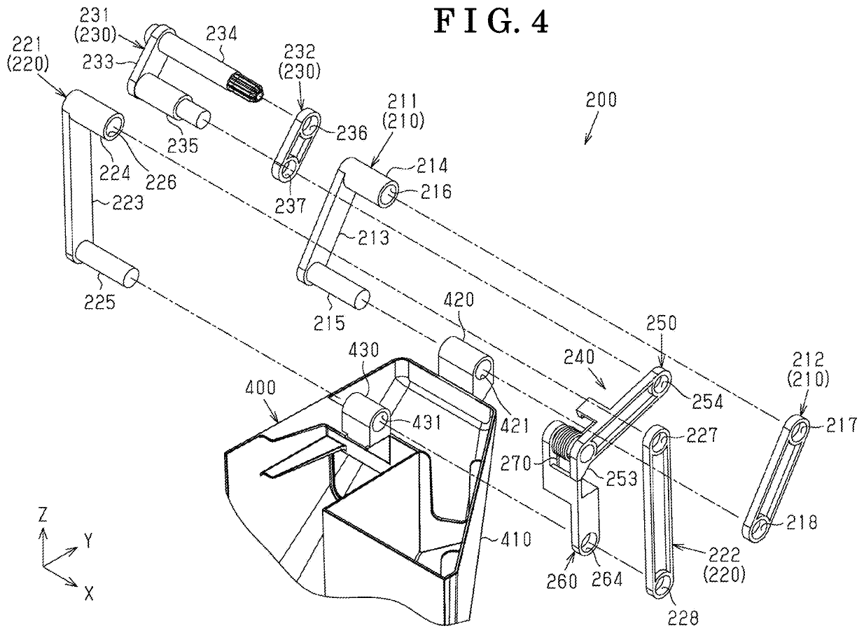

As shown in FIG. 4, the front link 210 includes a first front link 211 and a second front link 212 which are separately configured.

The first front link 211 includes a rod-shaped link body 213, a first tubular body 214 extending from a first end of the link body 213 in the width direction, and a first coupling shaft 215 extending from a second end of the link body 213 in the width direction. The first tubular body 214 has a cylindrical shape, and the first coupling shaft 215 has a columnar shape. In the first front link 211, a first support hole 216 whose axial direction is the width direction penetrates the first end of the link body 213 and the first tubular body 214. In the width direction, a length of the first tubular body 214 is slightly shorter than a length of the first coupling shaft 215.

The second front link 212 has a shape same as that of the link body 213 of the first front link 211. The second front link 212 includes a first support hole 217 that penetrates a first end of the second front link 212 in the width direction, and a first coupling hole 218 that penetrates a second end of the second front link 212 in the width direction. In a side view in the width direction, the first support hole 217 and the first coupling hole 218 have a circular shape.

### <Rear Link 220>

The rear link 220 includes a first rear link 221 and a second rear link 222 which are separately configured. The rear link 220 is longer than the front link 210.

The first rear link 221 includes a rod-shaped link body 223, a second tubular body 224 extending from a first end of the link body 223 in the width direction, and a second coupling shaft 225 from a second end of the link body 223 extending in the width direction. The second tubular body 224 has a cylindrical shape, and the second coupling shaft 225 has a columnar shape. In the first rear link 221, a second support hole 226 whose axial direction is the width direction penetrates the first end of the link body 223 and the second tubular body 224. In the width direction, a length of the second tubular body 224 is slightly shorter than a length of the second coupling shaft 225. The second rear link 222 has a shape same as that of the link body 223 of the first rear link 221. The second rear link 222 includes a second support hole 227 that penetrates a first end of the second rear link 222 in the width direction, and a second coupling hole 228 that penetrates a second end of the second rear link 222 in the width direction. In a side view in the width direction, the second support hole 227 and the second coupling hole 228 have a circular shape.

### <Drive Link 230>

The drive link 230 includes a first drive link 231 and a second drive link 232 which are separately configured. The drive link 230 is shorter than the front link 210 and the rear link 220.

The first drive link 231 includes a rod-shaped link body 233, a drive shaft 234 extending from a first end of the link body 233 in the width direction, and a third coupling shaft 235 extending from a second end of the link body 233 in the width direction. The drive shaft 234 penetrates the link body 233 in the width direction. The drive shaft 234 and the third coupling shaft 235 have a columnar shape. A length of the drive shaft 234 is longer than a length of the third coupling shaft 235. A tip end portion of the drive shaft 234, in other words, a portion of the drive shaft 234 to which a torque is transmitted from the actuator 300, has a spline shape.

The second drive link 232 has a shape same as that of the link body 233 of the first drive link 231. The second drive link 232 includes a shaft hole 236 that penetrates a first end of the second drive link 232 in the width direction, and a third coupling hole 237 that penetrates a second end of the second drive link 232 in the width direction. In a side view in the width direction, the shaft hole 236 and the third coupling hole 237 have a circular shape.

### <Transmission Link 240>

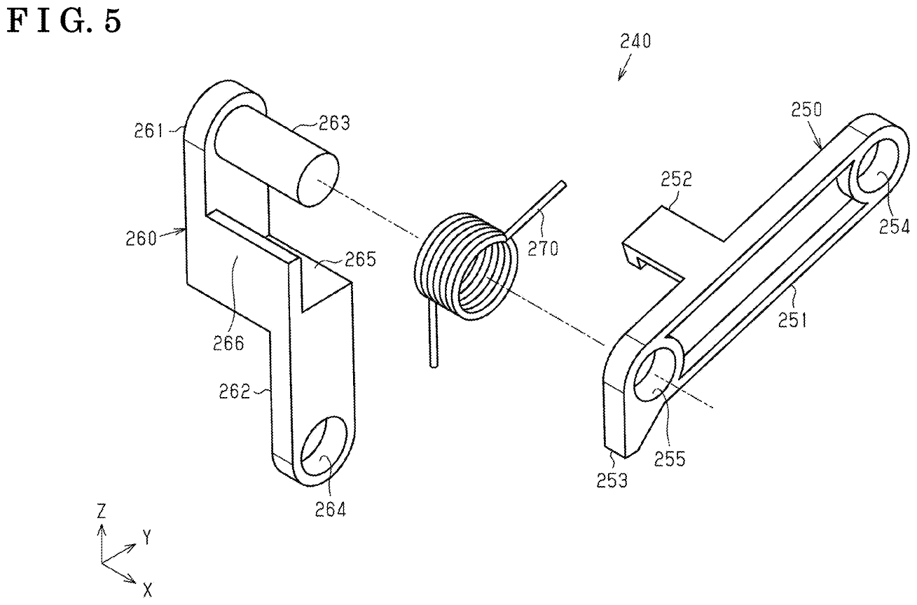

As shown in FIGS. 4 and 5, the transmission link 240 includes a first transmission link 250 and a second transmission link 260 which are separately configured, and a torsion spring 270 which biases the second transmission link 260 to the first transmission link 250. Unlike other links, the transmission link 240 is bent in a side view in the width direction.

The first transmission link 250 includes a rod-shaped link body 251, a holding portion 252 extending inward in the width direction from a center portion of the link body 251, and an engagement portion 253 extending from a second end of the link body 251 in a direction orthogonal to the width direction. The link body 251 of the first transmission link 250 includes a third coupling hole 254 that penetrates a first end of the link body 251 in the width direction, and a fourth coupling hole 255 that penetrates the second end of the link body 251 in the width direction. In a side view in the width direction, the third coupling hole 254 and the fourth coupling hole 255 have a circular shape. The holding portion 252 has a rectangular plate shape. A tip end of the holding portion 252 is bent. The engagement portion 253 tapers toward the tip end. A tip end surface of the engagement portion 253 has a planar shape.

The second transmission link 260 includes a rod-shaped first sub-link 261 and a second sub-link 262, a fourth coupling shaft 263 extending outward in the width direction from the first end of the first sub-link 261, and a second coupling hole 264 penetrating a second end of the second sub-link 262 in the width direction. The second transmission link 260 further includes a first connection wall 265 that connects a second end of the first sub-link 261 and a first end of the second sub-link 262 in the width direction, and a second connection wall 266 that connects the first sub-link 261 and the first connection wall 265.

The first sub-link 261 and the second sub-link 262 are located with an interval in the width direction. In a side view in the width direction, a direction in which the first sub-link 261 extends from the first connection wall 265 is opposite to a direction in which the second sub-link 262 extends from the first connection wall 265. The fourth coupling shaft 263 has a columnar shape. The second coupling hole 264 has a circular shape in a side view in the width direction. The first connection wall 265 and the second connection wall 266 each have a rectangular plate shape. A plate thickness direction of the first connection wall 265 and a plate thickness direction of the second connection wall 266 are orthogonal to each other. In this regard, it can be said that the second connection wall 266 reinforces the first connection wall 265. A gap is present between the second connection wall 266 and the fourth coupling shaft 263 in the longitudinal direction of the second transmission link 260.

The torsion spring 270 corresponds to a “spring”. The fourth coupling shaft 263 of the second transmission link 260 is inserted into a coil portion of the torsion spring 270. One end portion extending from the coil portion of the torsion spring 270 is engaged with the holding portion 252 of the first transmission link 250, and the other end portion extending from the coil portion of the torsion spring 270 is engaged with the second connection wall 266 of the second transmission link 260. At this time, the torsion spring 270 biases the first transmission link 250 and the second transmission link 260 in a direction of increasing an angle formed between the first transmission link 250 and the second transmission link 260 (hereinafter, also referred to as an “angle of the transmission link 240”). However, as shown in FIG. 4, the engagement portion 253 of the first transmission link 250 is engaged with the second connection wall 266 of the second transmission link 260, the angle of the transmission link 240 does not become larger than that shown in FIG. 4. In other words, by the engagement of the engagement portion 253 with the second connection wall 266, the second transmission link 260 is positioned relative to the first transmission link 250. A spring constant of the torsion spring 270 is set such that the angle of the transmission link 240 does not decrease when the spat 400 is normally operated. In the following description, a state of the transmission link 240 when the engagement portion 253 of the first transmission link 250 is engaged with the second connection wall 266 of the second transmission link 260 is also referred to as an “initial state”.

### <Actuator 300>

The actuator 300 is a power source of the spat device 40. The actuator 300 includes, for example, an electric motor and a speed reducer that decelerates a rotational speed of an output shaft of the electric motor. As shown in FIGS. 2 and 3, the actuator 300 is fixed to an outer surface of the second housing 120 via the two fixed shafts 125.

### <Spat 400>

As shown in FIGS. 2 and 3, the spat 400 includes a rectification portion 410 that rectifies an airflow around the front wheel 30 during traveling of the vehicle 10, a front support portion 420 coupled to the front link 210, and a rear support portion 430 coupled to the rear link 220.

In a situation in which the spat 400 is disposed at a deployed position where the spat 400 is deployed in a space in front of the front wheel 30, the rectification portion 410 is preferably inclined downward as the spat 400 goes rearward or outward in the width direction as the spat 400 goes rearward. As shown in FIG. 4, the front support portion 420 is provided at an upper portion of a front end of the spat 400. The front support portion 420 includes a first coupling hole 421 penetrating in the width direction. The rear support portion 430 is provided at a position rearward of the front support portion 420. The rear support portion 430 includes a second coupling hole 431 penetrating in the width direction. The positions of the front support portion 420 and the rear support portion 430 in the front-rear direction can be appropriately adjusted.

### <Engagement Relationship of Spat Device 40>

As shown in FIGS. 2 to 4, the first support shaft 112 of the first housing 110 is inserted into the first bearing portion 122 of the second housing 120 while passing through the first support hole 216 of the first front link 211 and the first support hole 217 of the second front link 212. In this way, a first end of the front link 210 is coupled to the first support shaft 112 of the first housing 110 in a relatively rotatable manner. As shown in FIG. 4, the first coupling shaft 215 of the first front link 211 passes through the first coupling hole 421 of the front support portion 420 of the spat 400 and the first coupling hole 218 of the second front link 212. In this way, a second end of the front link 210 and the front support portion 420 of the spat 400 are coupled to each other in a relatively rotatable manner.

As shown in FIGS. 2 to 4, the second support shaft 113 of the first housing 110 is inserted into the second bearing portion 123 of the second housing 120 while passing through the second support hole 226 of the second rear link 222 and the second support hole 227 of the second rear link 222. In this way, a first end of the rear link 220 is coupled to the second support shaft 113 of the first housing 110 in a relatively rotatable manner. As shown in FIG. 4, the second coupling shaft 225 of the first rear link 221 passes through the second coupling hole 431 of the rear support portion 430 of the spat 400, the second coupling hole 264 of the transmission link 240, and the second coupling hole 228 of the second rear link 222. In this way, a second end of the rear link 220, a second end of the transmission link 240, and the rear support portion 430 of the spat 400 are coupled in a relatively rotatable manner. The second transmission link 260 is located between the first rear link 221 and the second rear link 222.

As shown in FIGS. 3 and 4, the drive shaft 234 extending inward from the first drive link 231 is inserted into the bearing portion 114 of the first housing 110. On the other hand, the drive shaft 234 extending outward from the first drive link 231 passes through the shaft hole 236 of the second drive link 232 and the insertion hole 126 of the second housing 120. Further, the tip end of the drive shaft 234 extending outward from the first drive link 231 is connected to the actuator 300. In this way, the drive link 230 is rotatable about an axis of the drive shaft 234 based on power transmitted from the actuator 300. However, as shown in FIG. 3, the stopper 115 of the first housing 110 is present in a rotation range of the link body 233 of the first drive link 231. Therefore, when the drive link 230 rotates in a first rotation direction R1, the drive link 230 comes into contact with the first stopper 116, and when the drive link 230 rotates in a second rotation direction R2, the drive link 230 comes into contact with the second stopper 117.

As shown in FIG. 4, the third coupling shaft 235 of the first drive link 231 passes through the third coupling hole 237 of the second drive link 232 and the third coupling hole 254 of the transmission link 240. In this way, the drive link 230 and the transmission link 240 are coupled in a relatively rotatable manner about an axis of the third coupling shaft 235.

As described above, in the embodiment, the housing 100, the front link 210, the rear link 220, and the spat 400 constitute a double-lever link mechanism as a four-joint link mechanism. That is, a movement locus of the spat 400 is defined by the front link 210 and the rear link 220.

On the other hand, when the drive link 230 rotates, the power of the actuator 300 is transmitted to the spat 400 via the transmission link 240. More specifically, the power of the actuator 300 is transmitted as a force that pulls up the rear support portion 430 of the spat 400 upward and forward, or a force that pushes down the rear support portion 430 of the spat 400 downward and rearward. Further, based on the power of the actuator 300, the spat device 40 is disposed at a storage position at which the spat 400 is stored in the housing 100 or at a deployed position at which the spat 400 is deployed from the housing 100.

### Function of Embodiment

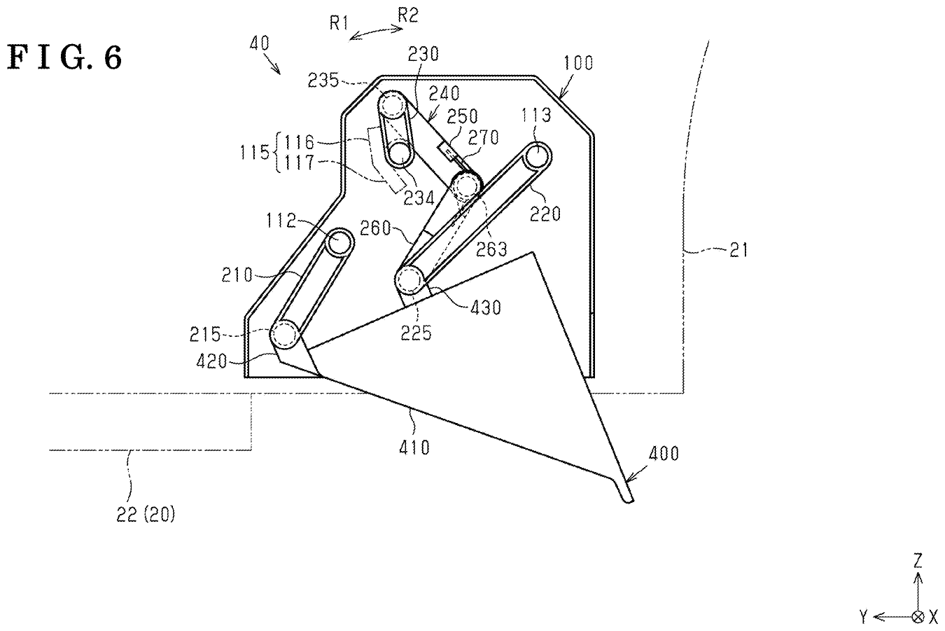

Function of the embodiment will be described with reference to FIGS. 6 to 9. In the spat device 40 shown in FIGS. 6 to 9, illustration of components of a part of the device is omitted or simplified.

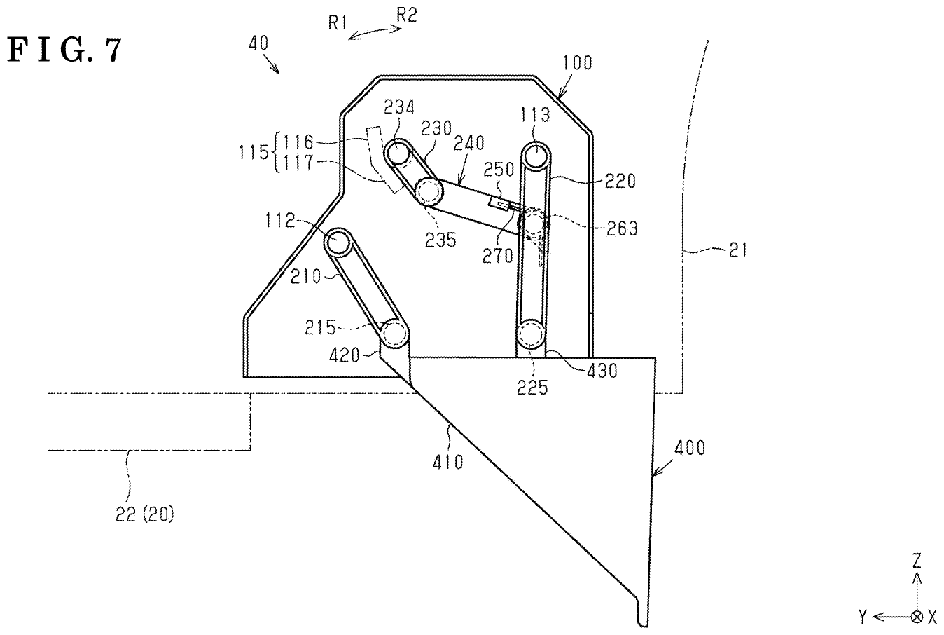

In the vehicle 10 including the spat device 40, when a storage condition of the spat 400 is satisfied, the spat 400 is operated toward a storage position shown in FIG. 6. On the other hand, when a deployment condition of the spat 400 is satisfied, the spat 400 is operated toward a deployed position shown in FIG. 7. The storage condition of the spat 400 is satisfied when a traveling speed of the vehicle 10 is lower than a determination speed, and the deployment condition of the spat 400 is satisfied when the traveling speed of the vehicle 10 is equal to or higher than the determination speed. As an example, the determination speed may be set to about several tens km/h.

A storage operation of the spat 400 will be described with reference to FIGS. 6 and 7.

When the spat 400 is located at the deployed position shown in FIG. 7, when the storage condition of the spat 400 is satisfied, the drive link 230 is rotated in the first rotation direction R1 by the actuator 300. Then, the second end of the transmission link 240 pulls the rear support portion 430 of the spat 400 forward and upward based on the power transmitted from the drive link 230. Then, the front link 210 swings about the axis of the first support shaft 112 such that the second end of the front link 210 moves forward, and the rear link 220 swings about the axis of the second support shaft 113 such that the second end of the rear link 220 moves forward and upward. As shown in FIG. 6, when the drive link 230 rotates to a storage corresponding position where the drive link 230 is in contact with the first stopper 116, the spat 400 is disposed at the storage position. That is, an amount of the spat 400 to be stored in the housing 100 is increased.

When the spat 400 is stored, a torque is applied to the transmission link 240 to increase the angle of the transmission link 240. However, even when the torque is applied to increase the angle of the transmission link 240, the engagement portion 253 of the first transmission link 250 is engaged with the second connection wall 266 of the second transmission link 260, and thus a change in the angle is prevented. That is, when the spat 400 is stored, the transmission link 240 is treated as a rigid link substantially maintaining the initial state.

As shown in FIG. 6, the storage corresponding position of the drive link 230 is a position at which the drive link 230 further rotates in the first rotation direction R1 than a state in which an axis of the third coupling shaft 235, an axis of the drive shaft 234, and an axis of the second coupling shaft 225 are linearly arranged. When the drive link 230 is located at the storage corresponding position, the axis of the third coupling shaft 235 is located forward of the axis of the drive shaft 234. Therefore, even when the actuator 300 does not transmit the power to the drive link 230, the spat 400 is prevented from moving from the storage position toward the deployed position based on its own weight acting on the spat 400. In the embodiment, even when the spat 400 is located at the storage position, the spat 400 protrudes downward from the undercover 22 of the vehicle 10. Therefore, even when the spat 400 is located at the storage position, the airflow around the front wheel 30 is adjusted.

A deployment operation of the spat 400 will be described with reference to FIGS. 6 and 7.

When the spat 400 is located at the storage position shown in FIG. 6, when the deployment condition of the spat 400 is satisfied, the drive link 230 is rotated in the second rotation direction R2 by the actuator 300. Then, the second end of the transmission link 240 pushes the rear support portion 430 of the spat 400 rearward and downward based on the power transmitted from the drive link 230. Then, the front link 210 swings about the axis of the first support shaft 112 such that the second end of the front link 210 moves rearward, and the rear link 220 swings about the axis of second support shaft 113 such that the second end of rear link 220 moves rearward and downward. As shown in FIG. 7, when the drive link 230 rotates to a deployment corresponding position where the drive link 230 is in contact with the second stopper 117, the spat 400 is disposed at the deployed position. That is, an amount of deployment of the spat 400 is maximized.

When the spat 400 is deployed, a torque is applied to the transmission link 240 to decrease the angle of the transmission link 240. In the embodiment, the spring constant of the torsion spring 270 is set such that the torque corresponding to a biasing force of the torsion spring 270 is larger than the torque acting on the transmission link 240 when the spat 400 is deployed about an axis of the fourth coupling shaft 263. Therefore, when the spat 400 is deployed, the angle of the transmission link 240 is prevented from decreasing. That is, when the spat 400 is deployed, the transmission link 240 is treated as a rigid link substantially maintaining the initial state, similarly to when the spat 400 is stored.

As shown in FIG. 7, when the spat 400 is located at the deployed position, the axis of the second coupling shaft 225 is located forward of the axis of the second support shaft 113. In other words, when the spat 400 is located at the deployed position, the first end of the rear link 220 is located rearward of the second end of the rear link 220. That is, the rear link 220 is inclined rearward.

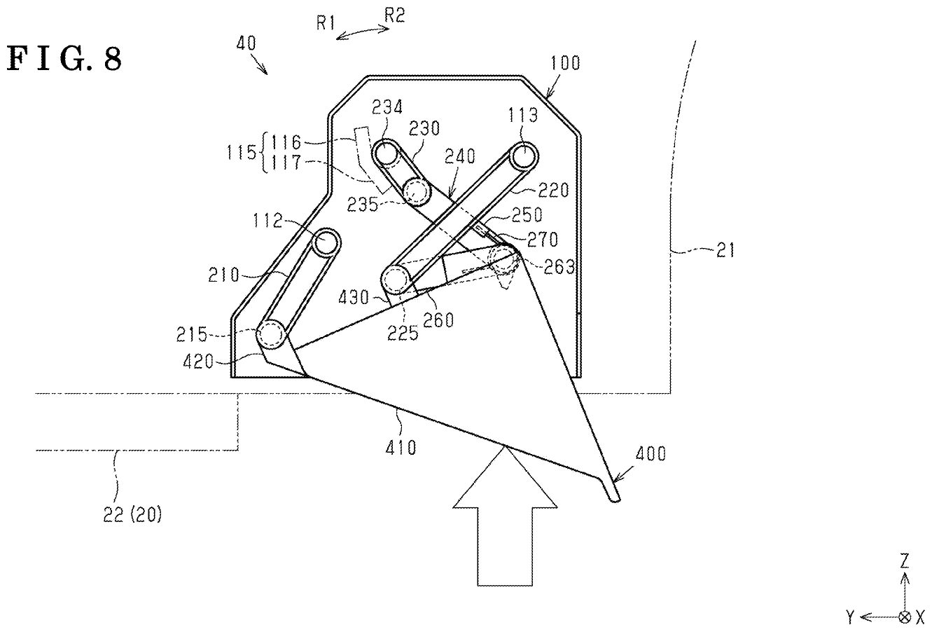

A retracting operation of the spat 400 located at the deployed position will be described with reference to FIGS. 7 and 8.

As shown in FIG. 7, when the spat 400 is located at the deployed position, the spat 400 protrudes greatly from the undercover 22 of the vehicle 10. Therefore, if an obstacle is present on the road surface on which the vehicle 10 travels, the obstacle may hit a forward-facing surface of the spat 400. Here, it is assumed that a height of the obstacle is lower than a minimum ground height of the vehicle 10.

As shown in FIGS. 7 and 8, when the spat 400 is located at the deployed position, when the obstacle comes into contact with the spat 400, a force to push the spat 400 upward acts as indicated by a white arrow in FIG. 8. Here, while the drive link 230 cannot rotate from the deployment corresponding position, the spat 400 is displaced upward. In other words, the second end of the transmission link 240 coupled to the rear support portion 430 of the spat 400 is displaced upward while the first end of the transmission link 240 coupled to the drive link 230 is fixed. As a result, the second transmission link 260 rotates about the axis of the fourth coupling shaft 263 with respect to the first transmission link 250 while the torsion spring 270 is elastically deformed. That is, the transmission link 240 is bent and the angle of the transmission link 240 decreases. In other words, an interval between the axis of the second coupling shaft 225 and the axis of the third coupling shaft 235 in the up-down direction is narrowed.

In this way, as shown in FIG. 8, the spat 400 is retracted from the deployed position. A movement locus of the spat 400 when the spat 400 is retracted from the deployed position is equal to a movement locus when the spat 400 is displaced from the deployed position to the storage position. An amount of retraction of the spat 400 from the deployed position varies depending on a direction and a magnitude of a force applied to the spat 400. That is, the amount of retraction of the spat 400 from the deployed position varies depending on a size of the obstacle.

When the spat 400 goes over the obstacle, an external force acting on the spat 400 is eliminated. Therefore, the angle of the transmission link 240 increases based on a restoring force of the torsion spring 270. When the transmission link 240 returns to the initial state, the spat 400 returns to the deployed position.

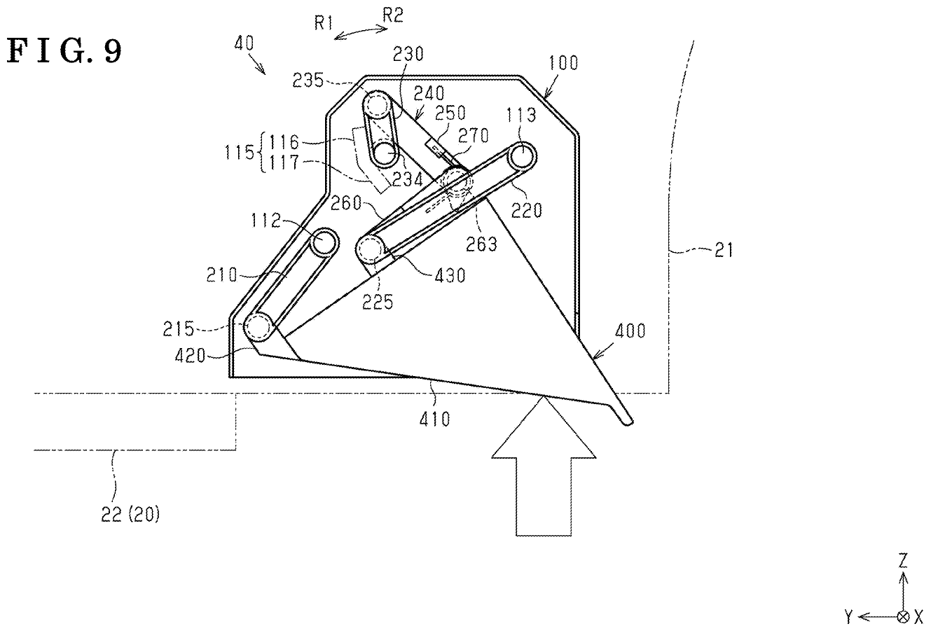

A retracting operation of the spat 400 located at the storage position will be described with reference to FIGS. 6 and 9.

As shown in FIG. 6, when the spat 400 is located at the storage position, the spat 400 protrudes slightly from the undercover 22 of the vehicle 10. Therefore, if an obstacle is present on the road surface on which the vehicle 10 travels, the obstacle may hit a forward-facing surface of the spat 400. For example, when a hard and large obstacle such as a stone is present, the obstacle may hit the spat 400 while the undercover 22 is deformed upward.

As shown in FIGS. 6 and 9, when the spat 400 is located at the storage position, when the obstacle comes into contact with the spat 400, a force to push the spat 400 upward acts as indicated by a white arrow in FIG. 9. Here, while the drive link 230 cannot rotate from the storage corresponding position, the spat 400 is displaced upward. In other words, the second end of the transmission link 240 coupled to the rear support portion 430 of the spat 400 is displaced upward while the first end of the transmission link 240 coupled to the drive link 230 is fixed. As a result, the second transmission link 260 rotates about the axis of the fourth coupling shaft 263 with respect to the first transmission link 250 while the torsion spring 270 is elastically deformed. That is, the transmission link 240 is bent and the angle of the transmission link 240 decreases. In other words, an interval between the axis of the second coupling shaft 225 and the axis of the third coupling shaft 235 in the up-down direction is narrowed.

In this way, as shown in FIG. 9, the spat 400 is retracted from the storage position. The movement locus of the spat 400 when the spat 400 is retracted from the deployed position is equal to an extension of the movement locus when the spat 400 is displaced from the deployed position to the storage position. An amount of retraction of the spat 400 from the deployed position varies depending on a direction and a magnitude of a force applied to the spat 400.

When the spat 400 goes over the obstacle, an external force acting on the spat 400 is eliminated. Therefore, the angle of the transmission link 240 increases based on a restoring force of the torsion spring 270. When the transmission link 240 returns to the initial state, the spat 400 returns to the storage position.

### Effects of Embodiment

(1) In the spat device 40, when an external force acts on the spat 400 in a situation in which the spat 400 is located at the deployed position, the spat 400 is retracted from the deployed position by elastically deforming the transmission link 240. That is, the spat device 40 can release the external force acting on the spat 400 by the elastic deformation of the transmission link 240. In this way, the spat device 40 can prevent a large load from acting on the components of the device.

(2) When an external force acts on the spat 400 in a situation in which the spat 400 is located at the deployed position, the second transmission link 260 rotates relative to the first transmission link 250 while the torsion spring 270 is elastically deformed. That is, the transmission link 240 is bent. In this way, the spat device 40 can retract the spat 400 from the deployed position by bending the transmission link 240 due to the elastic deformation of the torsion spring 270.

(3) A comparative example in which the first transmission link 250 does not include the engagement portion 253 is considered. In the comparative example, when the spat 400 is operated between the deployed position and the storage position, the angle of the transmission link 240 is unlikely to be determined. In this regard, the first transmission link 250 includes the engagement portion 253 for keeping the transmission link 240 in the initial state against the biasing force of the torsion spring 270. Therefore, when the spat 400 is operated between the deployed position and the storage position, the spat device 40 can keep the transmission link 240 in the initial state.

(4) In the spat device 40, the housing 100, the spat 400, the front link 210, and the rear link 220 constitute a double-lever mechanism. That is, the spat device 40 can define a movement locus between the storage position and the deployed position of the spat 400 by the front link 210 and the rear link 220. Further, the spat device 40 can match the movement locus of the spat 400 when the spat 400 is retracted with the movement locus of the spat 400 when the spat 400 is operated.

(5) When an external force acts on the spat 400 located in the deployed position, an upward load acts on a portion of rear link 220 coupled to the spat 400. Here, when the spat 400 is located at the deployed position, the axis of the second coupling shaft 225, which is a coupling axis between the rear link 220 and the spat 400, is located forward of the axis of the second support shaft 113, which is a coupling axis between the rear link 220 and the housing 100. In other words, the second end of the rear link 220 is located forward of the first end of the rear link 220. Therefore, when the external force acts on the spat 400, the axis of the second coupling shaft 225 is likely to move forward and upward. Therefore, the spat device 40 can easily retract the spat 400 from the deployed position toward the storage position when the external force acts on the spat 400.

(6) In a situation in which the vehicle 10 is traveling at a high speed, when the spat 400 is disposed at the deployed position, a wind pressure acts on the spat 400. In this case, the wind pressure acting on the spat 400 is transmitted to the transmission link 240 as a torque for increasing the angle of the transmission link 240. That is, a direction of the torque acting on the transmission link 240 based on the wind pressure acting on the spat 400 is the same as a direction of the torque acting on the transmission link 240 based on the biasing force of the torsion spring 270. Therefore, even when the wind pressure acts on the spat 400, the angle of the transmission link 240 does not increase from the initial state because the engagement portion 253 of the first transmission link 250 is engaged with the second transmission link 260. Therefore, the spat device 40 can stabilize a posture of the spat 400 at the deployed position.

(7) The spat 400 located at the storage position protrudes downward from the undercover 22. Therefore, even when the spat 400 is disposed at the storage position, the spat device 40 can rectify the airflow toward the front wheel 30. Further, when an obstacle comes into contact with the spat 400 located at the storage position, the spat device 40 can retract the spat 400, similarly to when an obstacle comes into contact with the spat 400 located at the deployed position.

### <Modification>

The embodiment can be modified as follows. The embodiment and the following modifications can be implemented in combination with each other as long as the embodiment and the modifications do not have technical contradiction.
In the spat 400, a portion coupled to the transmission link 240 may not be the rear support portion 430. For example, the second end of the transmission link 240 may be coupled to the front support portion 420 of the spat 400. The second end of the transmission link 240 may be coupled to a portion between the front support portion 420 and the rear support portion 430 of the spat 400.
The spat device 40 may gradually increase a deployment degree of the spat 400 to be proportional to a traveling speed of the vehicle 10.
The transmission link 240 may be formed of an elastomer such as rubber or resin. In this case, when an external force acts on the spat 400, the spat 400 is preferably retracted by elastically deforming the transmission link itself.
The transmission link 240 may be configured to be extendable and biased in an extension direction. For example, the transmission link 240 may be a transmission link including an inner cylinder serving as the first transmission link, an outer cylinder serving as the second transmission link, and a coil spring biasing the inner cylinder accommodated in the outer cylinder. The transmission link 240 may be a gas spring. In the case of the former transmission link, the coil spring corresponds to the “spring”, and in the case of the latter transmission link, a compressed gas corresponds to the “spring”. Such a transmission link retracts the spat 400 by contracting when an external force acts on the spat 400. Such a transmission link returns the spat 400 by extending when the external force acting on the spat is released.
The link unit 200 may include a guide rail for moving the spat 400 up and down with respect to the housing 100 instead of the front link 210 and the rear link 220. In this case, the spat 400 is displaced between the deployed position and the storage position by moving along the guide rail.
In the transmission link 240, the first transmission link 250 may not include the engagement portion 253.

Lengths and arrangement of a plurality of links constituting the link unit 200 can be changed as appropriate. In addition, postures of the plurality of links constituting the link unit 200 can be appropriately changed at the deployed position and the storage position.
The spat device 40 may be installed in front of a rear wheel as an example of a “wheel”.

### [Aspect 1]

According to an aspect of this disclosure, a vehicle spat device includes: a housing; a spat that adjusts an airflow toward a wheel of a vehicle by being displaced between a storage position at which the spat is stored in the housing and a deployed position at which the spat is deployed from the housing; a drive link that rotates between a position at which the spat is disposed at the storage position and a position at which the spat is disposed at the deployed position; and a transmission link that is coupled to the drive link and the spat in a relatively rotatable manner and transmits power of the drive link to the spat. When an external force acts on the spat, the transmission link moves to change a relative position between the drive link and the spat by the external force, and retracts the spat in a direction toward the housing.

### [Aspect 2]

In the vehicle spat device according to aspect 1, it is preferable that in a situation in which the spat is located at the deployed position, when the external force acts on the spat, the spat is retracted from the deployed position in the direction toward the housing.

In the vehicle spat device, when the external force acts on the spat in a situation in which the spat is located at the deployed position, the spat is retracted from the deployed position by elastically deforming the transmission link. That is, the vehicle spat device can release the external force acting on the spat by the elastic deformation of the transmission link. In this way, the vehicle spat device can mitigate the impact acting on the device.

### [Aspect 3]

In the vehicle spat device according to aspect 1, it is preferable that in a situation in which the spat is located at the storage position, when the external force acts on the spat, the spat is retracted from the storage position in the direction toward the housing.

### [Aspect 4]

In the vehicle spat device according to aspect 1, it is preferable that the transmission link includes a first transmission link coupled to the drive link in a relatively rotatable manner, a second transmission link coupled to the first transmission link and the spat in a relatively rotatable manner, and a torsion spring that biases the second transmission link to the first transmission link in a direction in which an angle formed between the first transmission link and the second transmission link increases.

When the external force acts on the spat in a situation in which the spat is located at the deployed position, the second transmission link rotates relative to the first transmission link while the torsion spring is elastically deformed. That is, the transmission link is bent such that the angle formed between the first transmission link and the second transmission link becomes smaller. In this way, the vehicle spat device can retract the spat from the deployed position by bending of the transmission link.

### [Aspect 5]

In the vehicle spat device according to aspect 4, it is preferable that one of the first transmission link and the second transmission link includes an engagement portion that positions the second transmission link, which is biased by the torsion spring, relative to the first transmission link by engaging with the other.

In a comparative example in which the first transmission link does not include the engagement portion, the angle formed between the first transmission link and the second transmission link is likely to change when the spat is operated between the deployed position and the storage position. In this regard, in the vehicle spat device, since one of the first transmission link and the second transmission link includes the engagement portion, the angle formed between the first transmission link and the second transmission link is less likely to change when the spat is operated between the deployed position and the storage position. Therefore, the vehicle spat device can stabilize the operation of the spat.

### [Aspect 6]

In the vehicle spat device according to aspect 1, it is preferable that the vehicle spat device includes a front link coupled to the housing and the spat in a relatively rotatable manner; and a rear link coupled to the housing and the spat in a relatively rotatable manner at a position rearward of the front link. The housing, the spat, the front link, and the rear link constitute a four-joint link mechanism.

The vehicle spat device can define a movement locus between the storage position and the deployed position of the spat by the front link and the rear link. For example, the vehicle spat device can easily adjust the movement locus of the rear link by changing lengths of the front link and the rear link.

### [Aspect 7]

In the vehicle spat device according to aspect 5, it is preferable that when the spat is displaced from the deployed position to the storage position, a coupling axis between the rear link and the spat is displaced forward and upward, and when the spat is located at the deployed position, the coupling axis between the rear link and the spat is located forward of a coupling axis between the rear link and the housing.

When the external force acts on the spat located in the deployed position, an upward load is likely to act on a portion of rear link coupled to the spat. Here, when the spat is located at the deployed position, the coupling axis between the rear link and the spat is located forward of the coupling axis between the rear link and the housing. Therefore, when the external force acts on the spat, the coupling axis between the rear link and the spat is likely to move forward and upward. Therefore, the vehicle spat device can easily retract the spat from the deployed position toward the storage position when the external force acts on the spat.

A vehicle spat device can mitigate an impact acting on the device when the device comes into contact with an obstacle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle spat device comprising:
a housing;
a spat that adjusts an airflow toward a wheel of a vehicle by being displaced between a storage position at which the spat is stored in the housing and a deployed position at which the spat is deployed from the housing;
a drive link that rotates between a position at which the spat is disposed at the storage position and a position at which the spat is disposed at the deployed position; and
a transmission link that is coupled to the drive link and the spat in a relatively rotatable manner and transmits power of the drive link to the spat, wherein
when an external force acts on the spat, the transmission link moves to change a relative position between the drive link and the spat by the external force, and retracts the spat in a direction toward the housing.

2. The vehicle spat device according to claim 1, wherein
in a situation in which the spat is located at the deployed position, when the external force acts on the spat, the spat is retracted from the deployed position in the direction toward the housing.

3. The vehicle spat device according to claim 1, wherein
in a situation in which the spat is located at the storage position, when the external force acts on the spat, the spat is retracted from the storage position in the direction toward the housing.

4. The vehicle spat device according to claim 1, wherein
the transmission link includes a first transmission link coupled to the drive link in a relatively rotatable manner, a second transmission link coupled to the first transmission link and the spat in a relatively rotatable manner, and a torsion spring that biases the second transmission link to the first transmission link in a direction in which an angle formed between the first transmission link and the second transmission link increases.

5. The vehicle spat device according to claim 4, wherein
one of the first transmission link and the second transmission link includes an engagement portion that positions the second transmission link, which is biased by the torsion spring, relative to the first transmission link by engaging with the other.

6. The vehicle spat device according to claim 1, further comprising:
a front link coupled to the housing and the spat in a relatively rotatable manner; and
a rear link coupled to the housing and the spat in a relatively rotatable manner at a position rearward of the front link, wherein
the housing, the spat, the front link, and the rear link constitute a four-joint link mechanism.

7. The vehicle spat device according to claim 5, wherein
when the spat is displaced from the deployed position to the storage position, a coupling axis between the rear link and the spat is displaced forward and upward, and
when the spat is located at the deployed position, the coupling axis between the rear link and the spat is located forward of a coupling axis between the rear link and the housing.
